(19) United States
(12) Patent Application Publication
(10) Pub. No.: US 2014/0302834 A1
(43) Pub. Date: Oct. 9, 2014

(54) MOBILE DEVICE TRACKING MONITORING SYSTEM AND DEVICE FOR ENFORCING ORGANIZATIONAL POLICIES AND NO DISTRACTED DRIVING PROTOCOLS

(71) Applicant: PORT NEXUS CORPORATION, Dania Beach, FL (US)

(72) Inventor: Steven Jones, Hollywood, FL (US)

(73) Assignee: Port Nexus Corporation, Dania Beach, FL (US)

(21) Appl. No.: 13/857,130

(22) Filed: Apr. 4, 2013

(51) Int. Cl. H04W 4/02

(52) U.S. Cl. CPC H04W 4/027
USPC 455/418

(57) ABSTRACT

A solution to mitigate organizational risks and exposure from damages and harm related to distracted driving. The invention includes a system, method, and devices that enable the organization to manage, monitor, and enforce corporate Mobile Device policies, in particular policies to deter and prevent distracted driving and encourage safe alternatives. A system for preventing distracted driving, including an Organizational Policy for anti-distracted driving including a rule and a Mobile Device configured to restrict, disable, or enable a feature of the Mobile Device based upon the rule.

### CROSS-REFERENCE TO RELATED APPLICATIONS

This application claims the benefit of U.S. Provisional Application for Patent No. 61/620,006 entitled MOBILE DEVICE TRACKING MONITORING SYSTEM AND DEVICE FOR ENFORCING ORGANIZATIONAL POLICIES AND NO DISTRACTED DRIVING PROTOCOLS, filed on Apr. 4, 2012, which is incorporated by reference herein in its entirety.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

Distracted driving, text messaging/texting while driving and emailing while driving, or making use of personal communicators, tablets, cellphones, pagers, personal computers, radio transmitters, radio receivers, electro-magnetic transmitters, electro-magnetic receivers, and other mobile communication devices (collectively each a “Mobile Device”) threatens organizations legally, financially, and socially. It threatens the lives of organizational agents, employees, their families, and others on and along the roadway. The Occupational Health and Safety Administration (OSHA) has asked employers to prohibit texting while driving, establish procedures and rules that prohibit texting and driving at work, and incorporate safe communication. Moreover, various states have begun implementing legislation banning texting while driving and requiring use of handsfree and BLUETOOTH while operating vehicles, which could create per se negligence and presumptions of reckless injury, putting organizations at risk for damages from tort claims and increasing insurance costs. Legal precedents already exist that have created problems and legal liability for organizations regarding the distracted driving of their employees. Courts have held that an employer is liable where a sales representative or employee is driving distracted. This has resulted in verdicts in the millions of dollars and costs organizations the distraction from business and lawyers fees of being involved in litigation. To address these existing problems associated with operating vehicles and or machinery while using mobile communications technology software developers have worked to establish systems to disable texting. However, the only solutions available are not configurable like the instant invention and do not provide for organizational control, policy enforcement and reporting.

Unfortunately, distracted driving has become the culture of many people, and there is little to no motivation for end users to implement or adopt solutions on an individual basis. Although employers, insurance companies, government agencies, celebrities, and members of the general public have all expressed concerns, culture and individual competitiveness/autonomy have hindered individual adoption and responsibility for refraining from distracted driving.

2. Description of the Related Art

Before the present invention there was not a solution to control organizational actors'/employees' behavior to enable the origination to protect itself in defense of the no-texting while driving policy and resulting actions. Prior to the invention, organizations had limited ability to protect themselves in litigation because of inability to enforce corporate no-texting while driving policies. Even when employees were suspected of texting or emailing in violation of corporate policy, there was no effective way to prove it until after the situation occurred. This is the major failure of other approaches aimed at implementing a texting while driving solution on mobile devices.

### SUMMARY OF INVENTION

The invention addresses these concerns, by using a novel approach directed toward an organizational policy enforcement and reporting system to change the culture by enabling organizational stakeholders who are better positioned and financially motivated to take control where it would be most effective and for the benefit of all.

The invention is an enterprise solution designed to provide feedback (report), control and surveillance of remote worker's actions pertaining to the environment in which they are operating and interacting with. This is to include, but is not be limited to, a system that allows an entity to set standards that are then enforced by interaction with a machine and reports back to a central system if the user is intentionally violating these standards.

In particular, the present invention relates to an enterprise solution to mitigate organization risks and exposure from damages and harm related to texting while driving. Part of the invention is an application deployed on a mobile device that provides the tools needed to govern the user, post use and report violations to a central system for forensic purposes and corporate management (the “Mobile Application”). A central dashboard, downloadable Management Console, and/or Application Programming Interface (collectively and separately the “Dashboard”) are provided by the invention for the organization to set policies and variables to be enforced and monitored on the Mobile Device and/or system. The Dashboard may have drop down, fill in, combo boxes, radio and other controls for configuration. A novel feature of the invention is that it enables corporate policies to be set at the Dashboard and enforced on individual devices using the Mobile Application.

The Mobile Application may be visible, undetectable, integrated into the mobile devices' operating system, hardware, or reside remotely. The Mobile Application follows organizational policies based on variables such as threshold speed, timing rules, and other attributes described herein (the “Organizational Policy”). Depending on the embodiment the settings and saved variables may reside on a mobile device, on the Dashboard server, another data server, or a combination of all three. Variables that may be set at the Dashboard include, but are not limited to: 1) the speed of device before engaging a locking mechanism or safe driving environment (“Safe Driving Mode”); 2) the time device remains below threshold speed before disengaging Safe Driving Mode; 3) the period of time a device is unlocked while in motion (in or out of compliance); 4) the URL of corporate compliance policy. The Dashboard also permits further configuration of the report and corporate policies.

Users are “in compliance” when they are within the limits established through the variables in the Organizational Policy. The invention captures interactions, messages and reports to the Dashboard when the user's actions are out of compliance. The invention utilizes the hardware of the user and optimizes internal systems such as GPS, RFID, accelerometers to increase the accuracy and extent of capturing information such as but not limited to, rate, location, events and actions. Actions include but are not limited to: email content, text messages, sender/recipient, phone number in and out going, speed, acceleration, deceleration; audio/video options; device input/output; BLUETOOTH activity; voice mails; time; rate; user; touch; user identity; and, who is information. Audio visual data may be translated to text or computer processable information. Actions are determined based upon the hardware triangulation and system resources available such as use of e911 chip, GPS antenna, near-fi radio, feed from Internet, altimeter, accelerometer, input output devices, microphone, touchscreen, keyboard, buttons, camera input, sensors, etc. In typical embodiments data is initially stored on the device and then relayed to the server upon a complete connection, but is also relayed in real time when possible.

In alternative embodiments, data may be collected even when users are in compliance. In some embodiments, the Mobile Application renders the mobile device useless unless the user is using a BLUETOOTH or alternative Organizational Policy approved device or method to communicate with safe input and output options to make or place calls/send messages, not driving, or admits they are breaking policy.

One objective of some embodiments of the invention is to distinguish between intentional and inadvertent violating of organizational policy. Notably, in this embodiment, the Mobile Application warns and forces the user to accept responsibility that they are breaking corporate policy. The front screen is designed to allow the company to post in bullets their policies if they want to but the user has to go through a series of steps to break policy intentionally. The present invention also distinguishes when a BLUETOOTH or safe input device is enabled, but user bypasses or chooses to use a non-safe method of input. Typically, this would indicate a training issue versus an intentional violation, and depending on Dashboard settings would be flagged in the Reporting Portal accordingly.

An example embodiment of the Mobile Application features: 1) blank screen except for a large, preferably red, unlock button that is displayed per company policy settings; 2) a warning screen that enforces awareness of the corporate policy; 3) buttons on screen to unlock device making it fully useable if not driving or in an emergency; and, 4) time selection as to how long the device should remain unlocked for use. The features and implementation of the Mobile Application may vary with the embodiment, mobile environment, device hardware, application framework and operating system.

The Mobile Application on the Device connects to a server via a computer network.

Either through the Dashboard, another network based portal, or software management system (collectively the “Reporting Portal”) users are able to retrieve history of actions including time, location, event incoming and outgoing addresses and how interacted.

The Reporting Portal provides a number of reports and configuration settings. For example, based upon the Organizational Policy the system can be configured such that an end user that sends a text message while a vehicle is motion then provides feedback to the user that the vehicle is in motion. Other warnings, sounds and visual displays can be used on the Mobile Device, through the Mobile Application, or via other means to notify the user of corporate policy and that their actions are being monitored for compliance, and that actions out of compliance are being logged and management/supervisors or the governing body alerted. These may include audio/visual indicators and prerecorded and computer automated messages.

### BRIEF DESCRIPTION OF THE DRAWINGS

The accompanying drawings, which are included to provide a further understanding of the invention and are incorporated in and constitute a part of this specification, illustrate embodiments of the invention and together with description serve to explain the principles of the invention.

In the drawings:

FIG. 1—Is a front view of a mobile phone.

FIG. 2—Is a front view of a Safe Driving screen of an application according to the invention.

FIG. 3—Is a front view of a screen of an application providing the user an option to affirmatively violate an Organizational Policy according to the invention.

FIG. 4—Is a front view of a screen of an application according to the invention providing the user the option to violate an Organizational Policy.

FIG. 5—Is a front view of a screen of an application according to the invention providing the user the option specify the amount of time for which they choose to affirmatively violate an Organizational Policy.

FIG. 6—Is a front view of a screen of an application according to the invention providing the user multiple options of predefined time periods from which they may select for affirmatively violating an Organizational Policy.

FIG. 7—Is a front view of a screen of an application according to the invention showing a view of a Reporting Portal showing recorded Actions and violations for a specific telephone number for a specific time period.

FIG. 8—Is a front view of a screen of the application showing an interface for the Dashboard to input Threshold, according to the invention of a Reporting Portal showing recorded Actions and violations for a specific telephone number for a specific time period.30] FIG. 9—Is a front view of a Dashboard screen on the Mobile Device that allows a user to set Organizational Policy rules.[0078] FIGS. 10A, 10B, and 10C—Are front views of three screens of the application according to the invention showing an interface for the Reporting Portal providing a place where the user may enter data to search for Actions or violations.

FIG. 11 is a flowchart of the process steps of the Dashboard application.

### DETAILED DESCRIPTION OF THE INVENTION

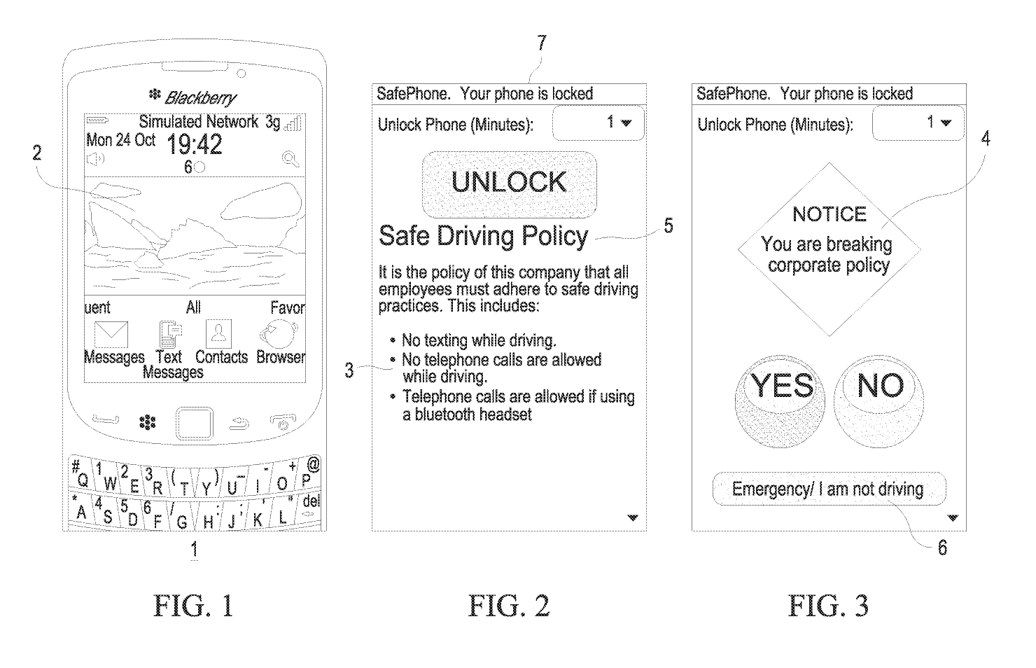

Several screens of an example embodiment of the invention are described in the drawings. FIG. 1 shows Mobile Device 1. The Mobile Device is connected wirelessly to a computer network and has a display screen and speaker for output. Mobile Device 1 may also provide USB, serial, radio and other electromagnetic input and output. Mobile Device 1 typically has one or more GPS tracking units, accelerometers and other means such as sensors or receivers for triangulation information over a computer network for detecting movement and estimating the speed of Mobile Device 1. Those skilled in the art appreciate other means of estimating speed and detecting movement of Mobile Device 1.

Mobile Devices typically have default configurations executable and controllable by computer code.

In an example embodiment, the invention disables, enables and restricts features of Mobile Device 1 based upon Organizational Policy 5. The Organizational Policy defines rules that are used by Mobile Device 1 or other computers of a computer network to control the Mobile Device.

For example, when the invention detects the speed of the Mobile Device through for example, its accelerometer, GPS antenna, or the computer network moving beyond threshold speed limit 26, the Mobile Device switches into Safe Driving Mode 7 where communication functions, such as, but not limited to, e-mail and text messages, are prohibited, as shown in FIG. 2. Once in Safe Driving Mode 7, Mobile Device 1 will change the output on tactile display 2 to reflect written policy 3 stored on the Mobile Device or on a server or remote network device and provide a means either through a button on the phone or an image drawn on tactile display 2 or other means established by Organizational Policy 5 to enable a user to unlock (e.g., temporarily disable) Safe Driving Mode 7. FIG. 3 shows an example embodiment of the invention that provides violation notice 4 to the user that they are breaking the Organizational Policy. Mobile Device 1 detects input from the user associated with one or more virtual (drawn on tactile screen 2) or actual buttons on Mobile Device 1. Alternatively, exception option 6 of the Mobile Device is configured for the user to advise that it is an emergency or that the user is not driving.

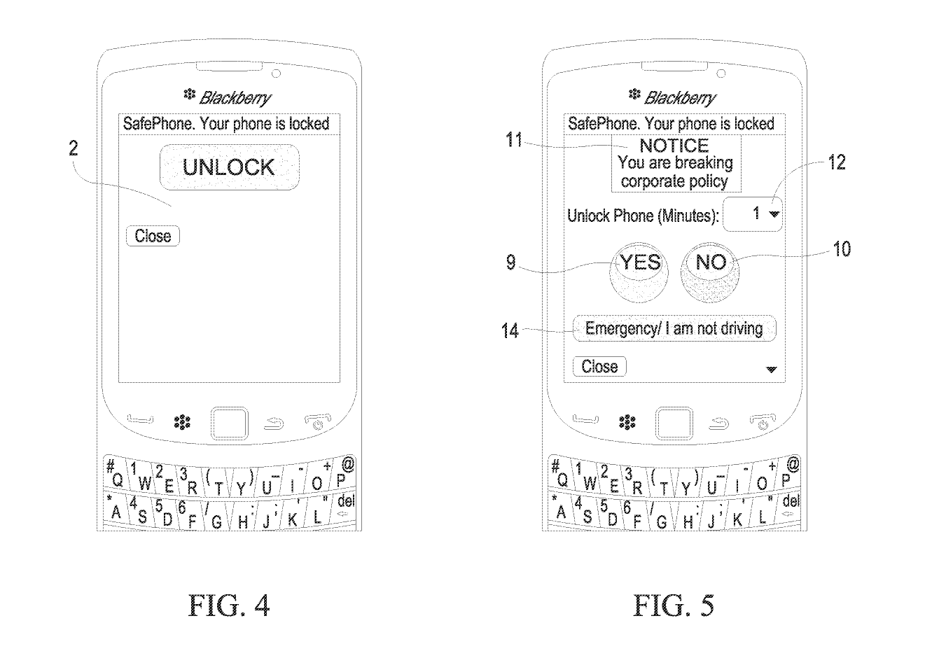

FIG. 4 shows that the invention includes Mobile Devices that do not provide a human readable written policy 3, or Safe Driving Policy, to the user.

FIG. 5 shows an example embodiment of the invention providing violation notice 4 of the Organizational Policy to the end user and an option for the end user to select period of time 12 to disable the Safe Phone mode and affirmatively violate policy. FIG. 5 also displays cancel option 10 to continue Safe Driving Mode 7, or continue option 9 to proceed with the violation of Organizational Policy 5. The invention also provides override 14 for the user of the Mobile Device to indicate that their apparent violation is excused because it is an emergency or they are not driving. In an example embodiment, override 14 may be combined as shown in FIG. 5 or separated into multiple options (e.g., two buttons, one for emergencies and the other to indicate that the user is not driving).

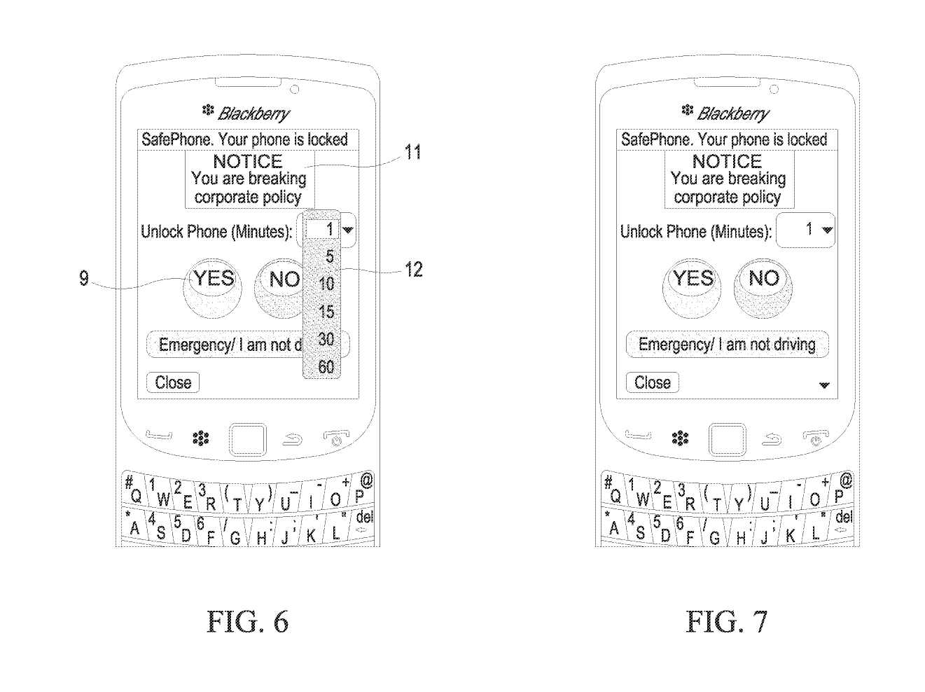

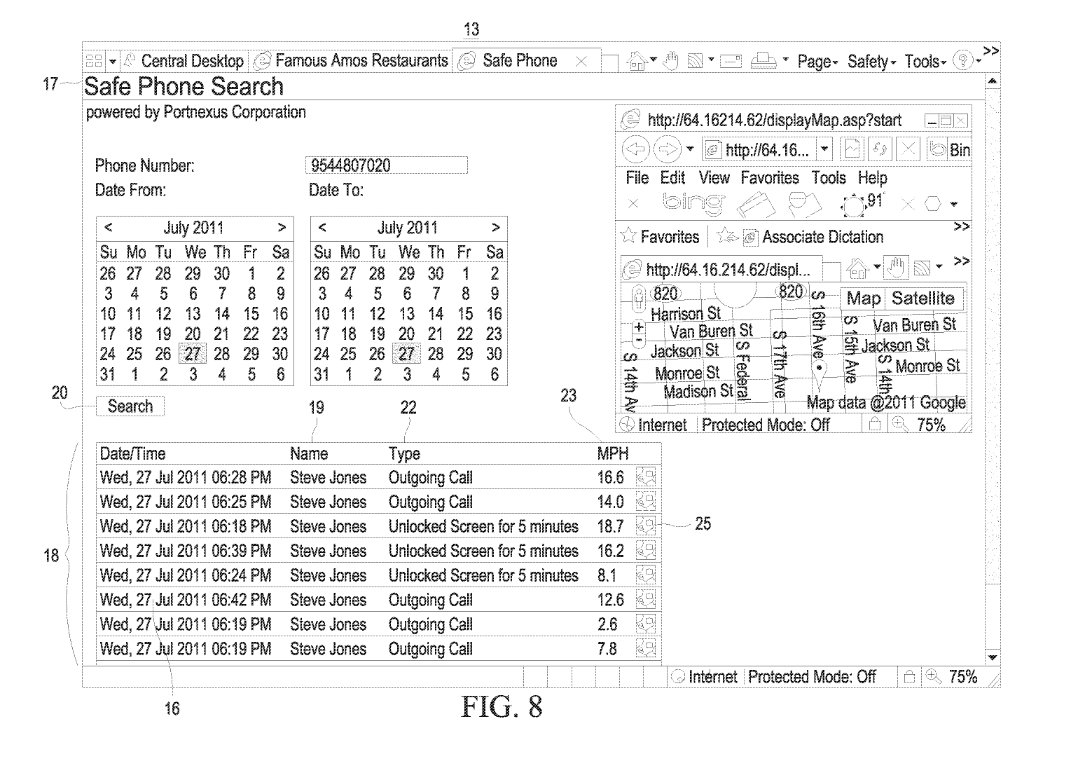

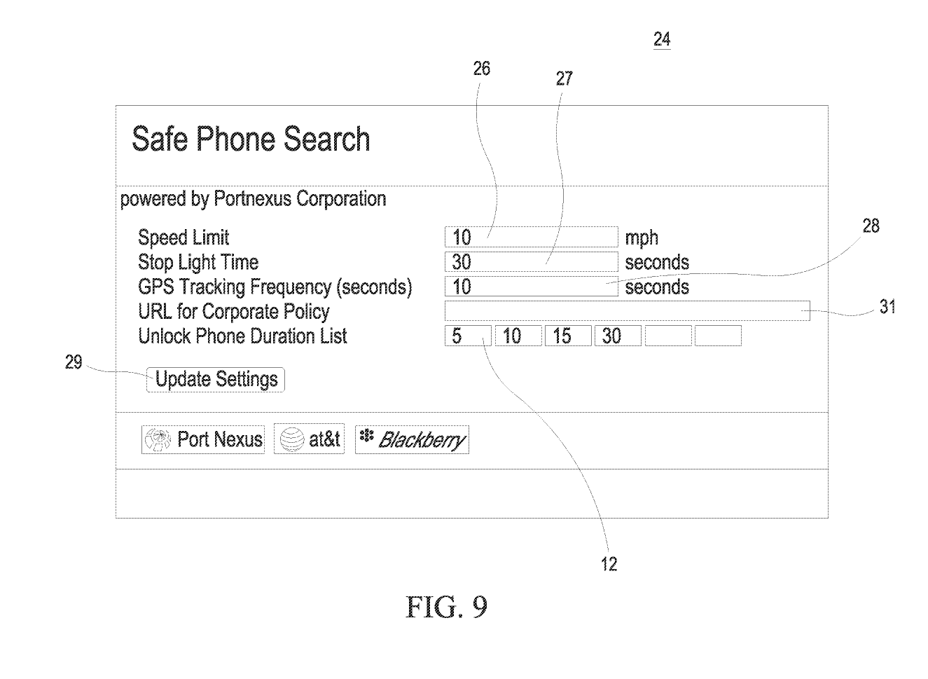

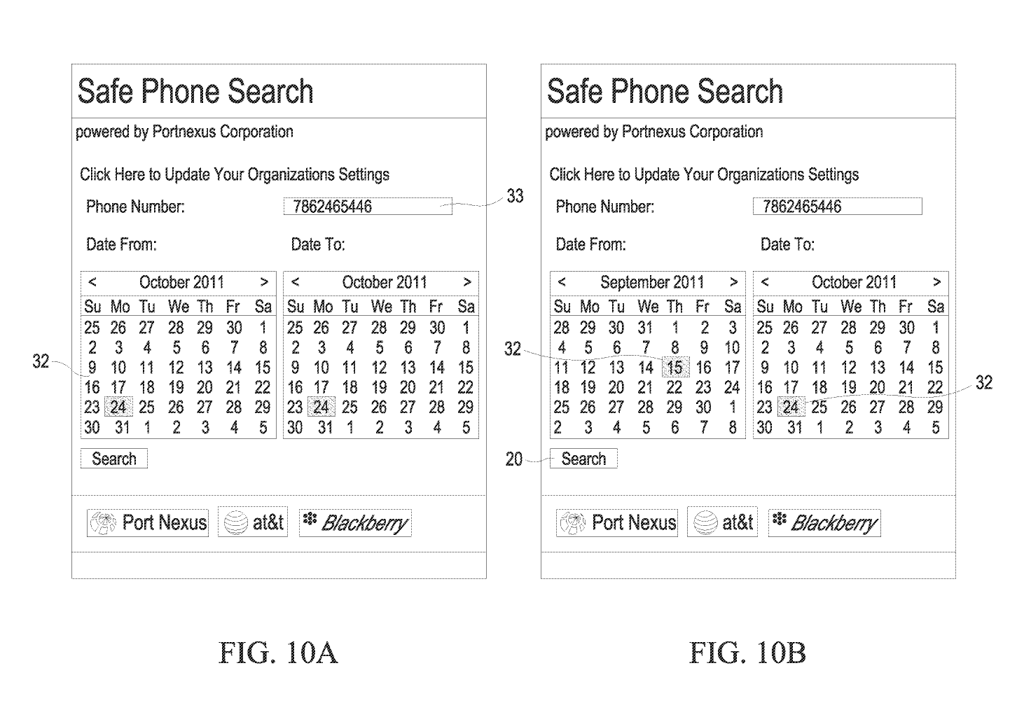

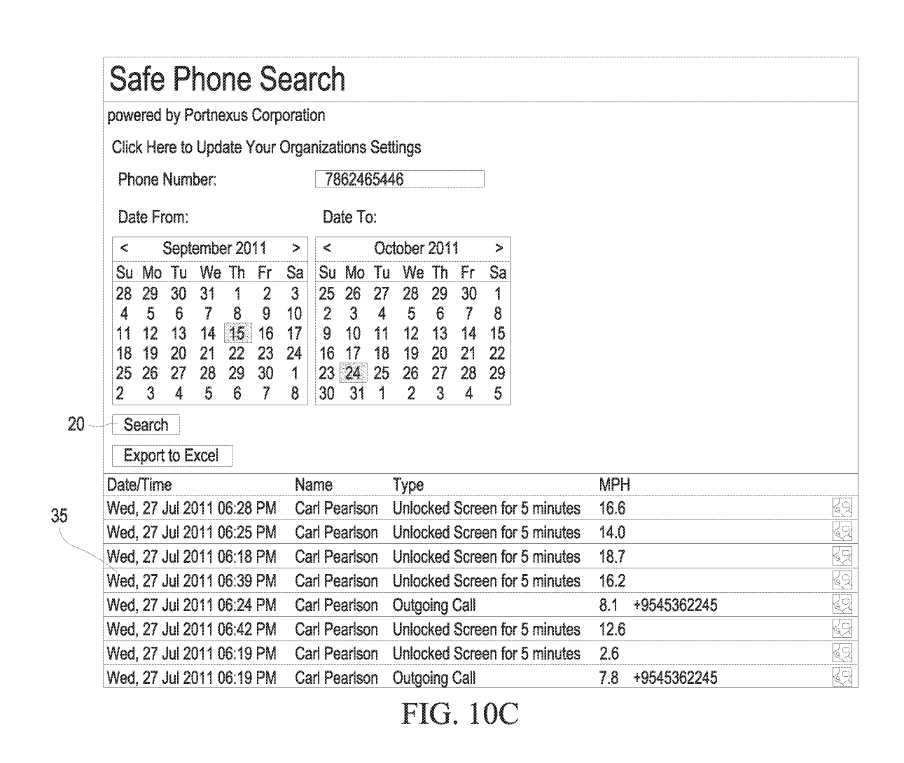

FIG. 6 shows an example embodiment where period of time 12 is input from a list of predetermined time periods such as, but not limited to, one, five, ten, fifteen, thirty minutes and an hour, or could be otherwise user specified through tactile display 2 or other buttons on Mobile Device 1, or another predefined list. FIG. 7 shows the application screen notifying the user of a violation of Corporate Policy. When a user is in violation of Organizational Policy 5, the Mobile Device either stores Action data or communicates Action data to a remote server or device. FIG. 8 shows reporting portal 13 that provides search option 17 and displaying stored Action data 18, such as time stamp 16, user name 19, Action type 22, user speed 23, and location data 25. The location data is displayed as an address, coordinates, a map, or another medium known to a person of ordinary skill in the art.

FIG. 9 shows a screen of Dashboard 24 that allows a user to set Organizational Policy 5 rules such as, Threshold speed limit 26, disengagement time 27, GPS and reporting frequency 28. In an example embodiment, disengagement time 27 refers to the time Safe Driving Mode 7 is bypassed when the mobile device is stationary or at a traffic stop light. Reporting frequency 28 is obtained, in an example embodiment, by polling the GPS to estimate the speed of Mobile Device 1. In addition, Dashboard 24 provides organizational policy entry 31 to allow a user to input a URL for a human readable corporate or Organizational Policy 5. Dashboard 24 allows a user to modify the predefined unlock duration list 15, as shown in FIG. 9.

FIGS. 10A, 10B, and 10C show multiple screens of reporting portal 13, which provide a means for searching recorded Action data 18 during violations of Organization Policy 5, such as date range 32 and phone number 33. In an example embodiment, a single day or multiple days are selected for date range 32. The user selects search button 20 and transaction report 35 appears detailing time stamp 16 of any incident, user name 19 of the person the phone number is assigned to, action type 22 reported from Mobile Device 1, and user speed 23 at the time of the incident. In an example embodiment, transaction report 35 includes other detailed information such as the body of the text message and a link to a map illustrating location data 25. In an example embodiment, transaction report 35 is exported to an Excel spreadsheet, and additional customizable reports are available.

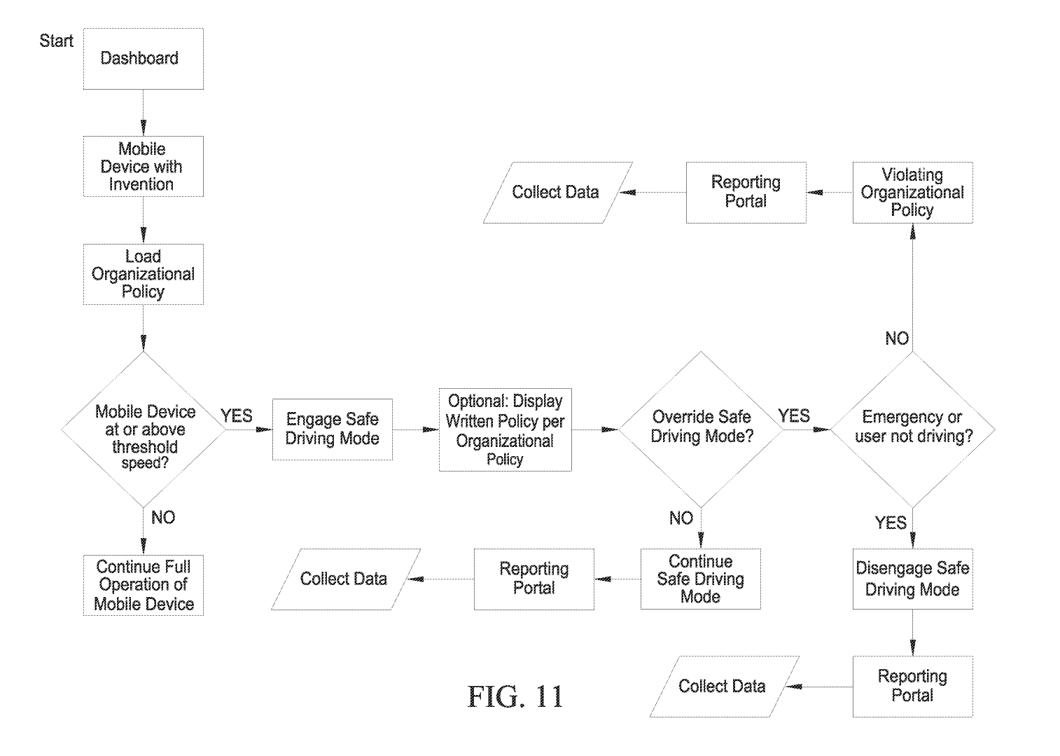

FIG. 11 is a flowchart of the process steps of the Dashboard application.

In an example embodiment, the criteria for Organizational Policy 5 are entered through Dashboard 24 by clicking on Update Settings 29 button. A page appears where the user can enter threshold speed limit 26 at which each Mobile Device 1 will enter Safe Driving Mode 7 as well as disengagement time 27. The user may also enter the URL for Organizational Policy 5 along with period of time 12 that the organizational agents and/or employees may choose for override 14, by selecting YES or Emergency/I am not Driving. Click Update Settings 29 to complete the process.

In an example embodiment, the system automatically responds to incoming messages with a predefined custom message, e.g., “Employee/recipient is driving and unable to send text messages by corporate policy, your request will be responded to as soon as possible once employee recipient is not longer driving.” In other words, a feature of safe driving mode 7 is an auto responder that sends an Organizational Policy or customaizable Mobile Device defined message to the sender of incoming text messages, cell phone calls, e-mails, or other communications to Mobile Device 1. This like the other options in the system may be enabled or disabled depending on settings at Dashboard 24.

Reporting Portal 13 also provides configuration of which actions are logged and which options have alerts associated with them, and what those alerts are. Various reports are able to be instantly generated through reporting portal 13 or scheduled or watched for future generation and distribution. In an example embodiment, Reporting Portal 13 is stored on Mobile Device 1 or on a remote device. Examples of some reports include:

### EXAMPLE 1

If an Incoming call is answered by unlocking the handset and/or pressing the green button on handset, the transaction report will display DATE, TIME, NAME OF USER, “INCOMING CALL” SPEED (IN MPH) and the INCOMING TELEPHONE NUMBER.

### EXAMPLE 2

If an Outgoing call is made by unlocking the handset and dialing, the transaction report will display DATE, TIME, NAME OF USER, “OUTGOING CALL” SPEED (IN MPH) and the OUTGOING TELEPHONE NUMBER

### EXAMPLE 3

If an Incoming call is answered by unlocking the handset and/or pressing the green button on handset even though BLUETOOTH is enabled, the transaction report will display DATE, TIME, NAME OF USER, “INCOMING CALL” SPEED (IN MPH) and the INCOMING TELEPHONE NUMBER (BLUETOOTH CONNECTED).

### EXAMPLE 4

If an Outgoing call is made by unlocking the handset and dialing even though BLUETOOTH is enabled, the transaction report will display DATE, TIME, NAME OF USER, “OUTGOING CALL” SPEED (IN MPH) and the OUTGOING TELEPHONE NUMBER (BLUETOOTH CONNECTED).

### EXAMPLE 5

If the handset is unlocked and a text is viewed, the transaction report will display DATE, TIME, NAME OF USER, “UNLOCKED SCREEN FOR X MINUTES” and the SPEED (IN MPH).

### EXAMPLE 6

If the handset is unlocked and a text is viewed and replied to, the transaction report will display DATE, TIME, NAME OF USER, “OUTGOING TEXT” SPEED, TELEPHONE NUMBER (TEXTED TO) and the BODY OF THE TEXT.

### EXAMPLE 7

If the handset is out of GPS range or the GPS receiver on the handset has been switched off, the transaction report will display DATE, NAME OF USER, TEXT or CALL TYPE, NUMBER TEXTED TO or CONTACTED TELEPHONE NUMBER and the BODY OF ANY TEXT.

Participating organizations have an option of displaying banners or being listed in a database of organizations, or membership of a group, that has taken steps or made a promise to proactively protect the organization, its employees, and/or others from distracted driving.

Another feature of the present invention is that it can be adapted to accommodate government mandates and deployed/activated over specific regions if legislation requires compliance by telecommunications providers.

The present invention creates evidence and a log of what a driver is or is not doing when in violation, notifies employee that they are about to be in violation, informs employee of the consequence of their violation. See, e.g., FIG. 8. When a violation occurs or is about to occur the present invention forces the employee to accept the violation by selecting continue option 9 and acknowledge the consequences of being out of compliance of Organizational Policy 5 The present invention then notifies (via email, SMS, the Dashboard, or other automated means) the organizational supervisors (e.g., human resources, management, corporate compliance) of the violative Actions and acceptance of the user.

Depending on Organizational Policy 5, violative devices can be controlled or locked based upon configurations in Dashboard 24, and penalties and/or corrective measures automatically, systematically, or a case-by-case basis imposed against violative or repeat violative users. Violation of policy and any combination of actions/event triggers can activate machines to take various applications alarms, phone calls made to warn tracking to begin of location for broadcast safety on other systems to include but not be limited to maps on the Internet, interaction with other machines to broadcast help in the area and intelligently notify other known entities (e.g., emergency services) of situations.

Additionally, the present invention identifies and flags violative or questionably violative activities and provides a mechanism to make an automated phone call, email, SMS or other communication, or any series thereof, to advise the appropriate party of the issues to review.

Another novel aspect of the present invention is the use of positive reinforcement and incentives to encourage compliance, to reward users for good performance and to provide a platform for entities to promote products. In an example embodiment, based on compliance and ticker type, the present invention may show awards that can be selected from Dashboard 24 as well as from Mobile Device 1. Incentives are based on user's age and other preferences, factors including but not limited to age, morality, mortality, location and interests. Thus, instead of or in addition to penalizing users for non-compliance, rewards are provided for compliance. Rewards include, cash, cash equivalents, redeemable/non-redeemable point systems, messages, credits for application stores, music, communication applications, video, games and other items that may be downloaded to the users device as well as access and/or credit coupons with various online and/or brick and mortar service providers. This may also allow other organizations, such as an insurance company, the ability to make offers based on performance directly to the user based on the credentials of the user established from a combination of machine and personal information being created. Additional incentives include, but are not limited to, clothes, food, free movie passes, music, charitable donations, and free concerts.

A further aspect of the invention is that it provides alternatives to mobile device locking to reduce employee complaints about reduction in productivity. For example, instead of locking a mobile device in motion, in a corporate vehicle, or transportation zone (e.g., located on a highway) the present invention could force all input/output to be through text to voice and voice to text. This inventive approach discourages and disincentives employee attempts at hacking and circumventing the system, as it provides a better and safer alternative to communication while operating a vehicle or machinery.

By implementing the system of the present invention, organizations take a proactive stance to discourage and enforce policies to avoid negligent behavior of their employees. By texting while driving occurring only when employees are intentionally acting outside corporate policy, the present invention insulates the organization from claims of negligence, and may reduce insurance costs. Furthermore, the present invention provides evidence of proactive action by company, proof of employee awareness and acceptance of consequences of employees' actions. Just as celebrities have made public service announcements to discourage texting while driving, the proactive approach at the organizational level has the added value of positive public relations and improved image for the organization.

As an additional benefit, the system can also be configured as a black box to create forensic data in the event of an accident and/or crash, for defense in legal actions.

Data may be stored on the mobile device, or a central server or both. Standard reports are available on the server and the data will be stored such that other reports and analysis can be implemented through plug-ins or system extensions for enforcing additional corporate policies through the mobile devices and Dashboard 24. By example, organizational policy 5 may be stored on the device or shown through an html link/iframe/browser or web link or various other methods known in the art.

Although it is recommended that exceptions be provided for emergencies, as an additional option the product can be configured to systemize adherence to organizational policies without exception.

Moreover, unlike other text to speech systems the present invention uses a multithreaded and/or clustered engine to enable real time and near real time processing of large amounts of voice data. The percentage of time an employee is driving and not able to work effectively will create a drop in productivity, personal happiness and a drop in profits to the organization.

The present invention enables organizations to maintain or increase profits efficiency and be completely compliant with distracted driving laws and social expectations.

Some embodiments of the system further provide the ability for users to interact safely through controlled communication channels and interact with a unified scheduling and messaging system. Additionally, users are able to share information that is managed through another mentor that adheres to standards set by an entity such as a family, school or organization this information is to include but not be limited to, location, image, (photo/video) text, voice and actions. This extension to the system includes standards to help organize, alert and verify, and may optionally include the ability to have a library of known words to search and restrain by from use or alert others of use of. Thus, the present invention provides the total base tools and framework that may be applied to families and communities as the organization.

Thus, the present invention not only takes a novel approach to addressing a cultural problem it also provides the organization with the novel tools needed to educate the users on proper use and adherence to corporate policy and evidence needed to enforce violations and prove proactive position for forensics.

Although the general range and preferred settings may vary by user and organizational goals/expectations, typical ranges are three to twenty miles per hour, with a typical setting of ten miles per hour. Any amount of time may be used for the time while the device must be below the threshold speed before unlocking, but typical values range from fifteen seconds to five minutes, approximately forty-five seconds works for many applications.

### EXAMPLE 8

A threshold speed of 10 miles per hour (the “Threshold Speed”), and time limit to enable a device after a threshold event of 45 seconds (the “Time Limit”) is set in the Dashboard. The mobile device then locks once it exceeds the Threshold Speed, and remains locked until the mobile device decelerates to below the threshold speed for the Time Limit before unlocking

### EXAMPLE 9

A threshold speed of 10 miles per hour (the “Threshold Speed”), and time limit to enable a device after a threshold event of 2 minutes (the “Time Limit”) is set in the Dashboard. The mobile device then locks once it exceeds the Threshold Speed, and remains locked until: 1) the mobile device decelerates to below the threshold speed for the Time Limit before unlocking; or 2) the user agrees to break protocol or indicates that is an emergency or they are not driving.

### EXAMPLE 10

A threshold speed of 10 miles per hour (the “Threshold Speed”), and time limit to enable a device after a threshold event of 2 minutes (the “Time Limit”) is set in the Dashboard. The mobile device then locks once it exceeds the Threshold Speed, and remains locked until: 1) the mobile device decelerates to below the threshold speed for the Time Limit before unlocking; or 2) the user agrees to break protocol or indicates that is an emergency or they are not driving.

### EXAMPLE 11

A threshold speed of 10 miles per hour (the “Threshold Speed”), and time limit to enable a device after a threshold event of 2 minutes (the “Time Limit”) is set in the Dashboard. The mobile device then locks once it exceeds the Threshold Speed. Next, the user agrees to break protocol, and selects the amount of time the device will remain out of compliance. This selection or indication is reported to the Reporting Portal along with other user data recorded by the System.

### EXAMPLE 12

An organizational stakeholder accesses the Reporting Portal where they can search for data by username, mobile number, date, location or other critical information and retrieve a report in HTML, PDF, EXCEL, CSV or other suitable format for review and further analysis.

Having thus described preferred embodiments, it should be apparent to those skilled in the art that certain advantages of the described system have been achieved. It should also be appreciated that various modifications, adaptions, and alternative embodiments thereof may be made within the scope and spirit of the present invention. The invention is further defined by the following claims.

What is claimed is:

1. A system for preventing distracted driving, comprising:
an Organizational Policy for anti-distracted driving including a rule; and
a Mobile Device configured to perform at least one of the following: restrict, disable or enable a feature of the Mobile Device based upon said rule.

2. The system of claim 1 wherein said rule includes a threshold value for speed.

3. The system of claim 2 wherein the Mobile Device is configured to:
enable a Safe Driving Mode while the Mobile Device is moving at or above said threshold value for speed; or disable the Safe Driving Mode while the Mobile Device is moving below said threshold values for speed.

4. The system of claim 2 wherein said feature is a voice recognition input.

5. The system of claim 2 wherein the Mobile Device is configured to perform at least one of the following:
enable, disable or require text to speech or audible output for the Mobile Device while the Mobile Device is moving based upon said threshold values for speed.

6. The system of claim 2 wherein the Mobile Device is configured to communicate with at least one of the following:
a Dashboard, Remote Portal or other remote device to determine said rules of the Organizational Policy.

7. The system of claim 2 wherein at least one of said threshold values for speed is constant.

8. The system of claim 2 wherein at least one of said threshold values for speed is variable.

9. The system of claim 2 wherein the Mobile Device is configured to select output through at least one specified output device when the Mobile Device is moving at or above the threshold values for speed, wherein said specified output device is designated from at least one of the following: rules of the Organizational Policy, system variables, system constants, system rules or a Mobile Application.

10. The system of claim 2 wherein the Mobile Device is configured to select input and output devices based upon the Organizational Policy.

11. The system of claim 3 wherein the Mobile Device is further configured to enable the user to override the Organization Policy.

12. The system of claim 3 wherein the Mobile Device performs at least one of the following tasks: generate reports or store logs regarding violations of the Organizational Policy.

13. The system of claim 12 wherein the Mobile Device stores data regarding violations of the Organizational Policy.

14. The system of claim 13 wherein the Organizational Policy is configured through a Dashboard.

15. The system of claim 14 wherein the Mobile Device is configured to transmit Action data to a Reporting Portal.

16. A method of enforcing an Organizational Policy for anti-distracted driving, which comprises:
a. using an Organizational Policy that is one of the following: default or custom;
b. enforcing said Organizational Policy through at least one Mobile Device by performing at least one of the following: enabling, disabling or requiring hands free input, voice input, or audible output for said Mobile Devices.

17. The method of claim 16 further comprising:
a. configuring the Mobile Devices to permit an end user to affirmatively violate the Organizational Policy for anti-distracted driving; and,
b. collecting data regarding the end user's violation of the Organizational Policy for anti-distracted driving, including at least one of the following data elements:
i. user identification;
ii. date;
iii. time;
iv. user location;
v. speed of the device;
vi. acceleration of the device;
vii. duration of violation;
viii. actions taken during violation;
ix. data transmitted to the Mobile Device during the violation; and
x. data transmitted from the Mobile Device during the violation.

18. The method of claim 17 wherein the data element is reviewable through a Reporting Portal.

19. A Mobile Device, comprising:
a. memory storing computer instructions to restrict, enable or disable features pursuant to at least one Organizational Policy for anti-distracted driving, wherein said Organizational Policy is configured by a Dashboard; and,
b. memory storing computer instructions that provide a graphic user interface to a user of the Mobile Device, wherein the graphic user interface allows the user to affirmatively violate the Organizational Policy.

20. The Mobile Device of claim 19, further comprising memory storing computer instructions that store or transmit to the Dashboard or Reporting Portal violations of the Organizational Policy, wherein said violations are processed as data elements, and the data elements include at least one of the following:
k. user identification;
l. date;
m. time;
n. user location;
o. speed of the device;
P. acceleration of the device;
q. duration of violation;
r. actions taken during violation;
s. data transmitted to the Mobile Device during the violation; and,
t. data transmitted from the Mobile Device during the violation.
